(19) United States
(12) Patent Application Publication
(10) Pub. No.: US 2019/0283539 A1
(43) Pub. Date: Sep. 19, 2019

(54) ARRANGEMENT FOR HEATING A VEHICLE INTERIOR

(71) Applicant: Mahle International GmbH, Stuttgart (DE)

(72) Inventors: Oliver Schultze, Stuttgart (DE); Joachim Treier, Oppenau (DE)

(21) Appl. No.: 16/354,976

(22) Filed: Mar. 15, 2019

(30) Foreign Application Priority Data
Mar. 16, 2018 (DE) 102018204059.1

(51) Int. Cl. B60H 1/22; B60H 1/00

(52) U.S. Cl. CPC B60H 1/2225; B60H 2001/2287; B60H 1/00564

(57) ABSTRACT

An arrangement may be configured for heating a vehicle interior of a motor vehicle. The arrangement comprises an air duct for air to flow through. In a cross section perpendicular to the direction of extension thereof, the air duct comprises a first duct zone, via which the air can be introduced into a first interior zone of the vehicle interior, and a second duct zone, via which the air can be introduced into a second interior zone of the vehicle interior. The arrangement comprises a heating device arranged in the air duct, comprising a plurality of heating sections, which extend along a longitudinal direction and perpendicular to the direction of extension in the air duct, have electrical PTC heating elements and are arranged adjacent to one another along a stack direction perpendicular to the longitudinal direction and direction of extension.

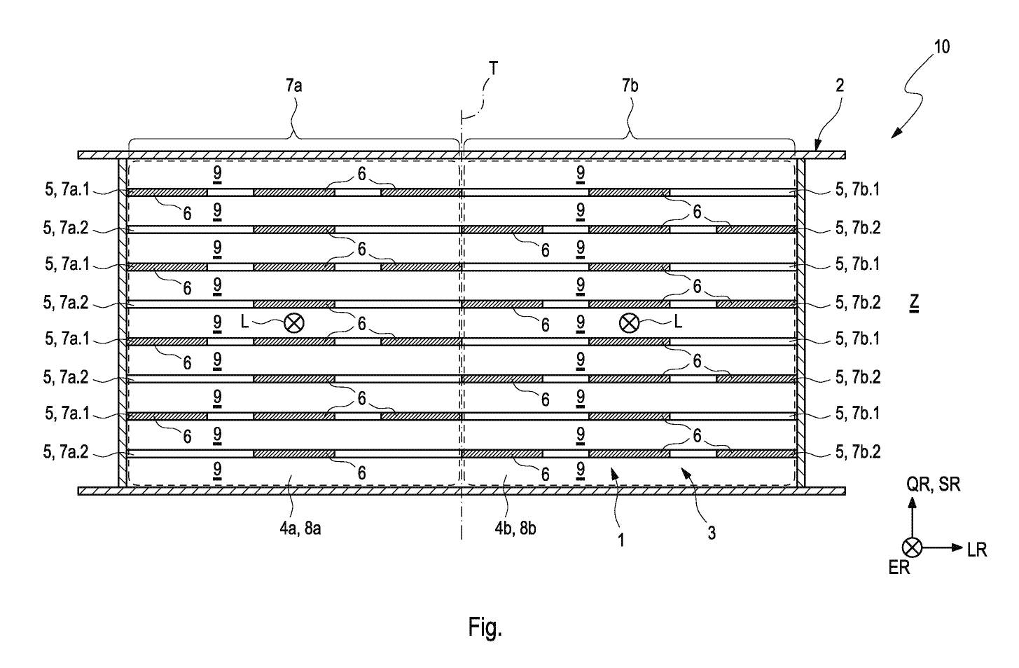

### CROSS-REFERENCE TO RELATED APPLICATION

This application claims priority to German Application DE 10 2018 204 059.1 filed Mar. 16, 2018, the contents of which are hereby incorporated by reference in its entirety.

### TECHNICAL FIELD

The present invention relates to an arrangement comprising a heating device having PTC heating elements for heating a vehicle interior of a motor vehicle. The invention further relates to a motor vehicle comprising such an arrangement.

### BACKGROUND

Electrically operated PTC heating elements for heating devices have a high process safety and do not overheat. Due to these advantageous characteristics, PTC heating elements are in particular used in the automobile sector. PTC heating elements are used for the vehicle interior heating, among other things.

### SUMMARY

It is an object of the present invention to show new ways in the development of arrangements for heating vehicle interiors by means of electrical PTC heating elements. An arrangement is to in particular be created, which makes it possible in a technically simple and thus cost-efficient manner to supply a heating power, which is as homogenous as possible, to different interior zones of a vehicle interior.

An arrangement according to the invention for heating a vehicle interior of a motor vehicle comprises an air duct extending along a direction of extension and being defined by a duct housing, for air to flow through. In a cross section perpendicular to the direction of extension, the air duct comprises a first duct zone, via which the air can be introduced into a first interior zone of the vehicle interior, and a second duct zone, via which the air can be introduced into a second interior zone of the vehicle interior. The arrangement furthermore comprises at least one heating device arranged in the air duct. The heating device comprises a plurality of heating sections, which extend along a longitudinal direction and perpendicular to the direction of extension in the air duct, have electrical PTC heating elements and are arranged adjacent to one another along a stack direction perpendicular to the longitudinal direction and direction of extension. Each heating section is thereby divided at least into a first section portion, which is arranged in the first duct zone, and into a second section portion, which is arranged in the second duct zone. According to the invention, two first section portions, which are adjacent in the stack direction, have a different number of PTC heating element heating elements. In each case, two second section portions, which are adjacent in the stack direction, likewise have a different number of PTC heating elements. The total number of required PTC heating elements can be kept low in this way, so that the pressure loss in the air passing through the PTC heating elements can be kept low. Cost advantages in the production of the heating device also result. As a result, a particularly homogenous heating power can be provided easily and thus cost-efficiently in this way in different interior zones of the vehicle by means of heated air.

According to this embodiment, a first section portion of the first type, which has a first number of PTC heating elements, is arranged along the stack direction adjacent to a first section portion of the second type, which has a second number of PTC heating elements, which differs from the first number. In the case of this embodiment, a second section portion of the second type, which has a first number of PTC heating elements, is alternatively or additionally arranged along the stack direction adjacent to a second section portion, which has a second number of PTC heating elements, which differs from the first number.

According to an advantageous further development, first section portions of the first type and first section portions of the second type alternate along the stack direction.

In the case of this further development, second section portions of the first type and second section portions of the second type alternatively or additionally alternate along the stack direction.

According to another preferred embodiment, the number of all electrical PTC heating elements, which are arranged in the first section portions, is identical to the number of all electrical PTC heating elements, which are arranged in the second section portions.

Particularly advantageously, the number of all PTC heating elements, which are present in the first heating sections of the first type, is identical to the number of all PTC heating elements, which are present in the first heating sections of the second type. In the case of this alternative, the number of all PTC heating elements, which are present in the second heating sections of the first type, is alternatively or additionally identical to the number of all PTC heating elements, which are present in the first heating sections of the second type.

According to a preferred embodiment, a different number of electrical PTC heating elements is provided in at least one heating section, preferably in at least two heating sections, highly preferably in every heating section, in the first section portion thereof than in the second section portion thereof.

In the case of a further preferred embodiment, no electrical PTC heating element is arranged in at least one heating section, preferably in at least two heating sections, in the first or in the second section portion. This alternative is associated with particularly low production costs.

Particularly advantageously, the heating sections comprising the PTC heating elements are arranged in a plane perpendicular to the direction of extension. It is ensured in this way that the PTC heating element heating elements are flown through perpendicular to the main flow direction of the air in the air duct. The pressure drop created by the heating sections is thus particularly low.

Particularly preferably, a cross sectional surface of the first duct zone is of the same size as a cross sectional surface of the second duct zone in the cross section perpendicular to the direction of extension.

According to an advantageous further development, an axis of symmetry, which halves the duct section of the air duct into two duct halves arranged axially symmetrically to one another, which form the first and second duct zone, is present in the cross section perpendicular to the direction of extension.

Advantageously, the heating sections extend along a joint longitudinal direction and are arranged at a distance from one another with regard to a transverse direction running at right angles to the longitudinal direction. In this way, the air can pass through the spaces, which are in each case formed between two adjacent heating sections.

Particularly preferably, the PTC heating elements are embodied as identical parts. In that identical parts are used, the desired different heating powers in the two duct zones can be realized in a simple manner by means of suitable adaptation of the number of the PTC heating elements arranged in the two duct zones. This embodiment is thus associated with particularly low production costs.

In the case of a further preferred embodiment, all PTC heating elements are connected to an electrical power supply during operation of the at least one heating device, so that a first electrical total heating power is generated by means of the totality of all electrical PTC heating elements, which are arranged in the first duct zone. This first electrical total heating power is identical to a second electrical total heating power, which is generated by all PTC heating elements, which are arranged in the second duct zone.

According to another preferred embodiment, at least one heating section of the heating device is electrically connected to the electrical power supply by means of a semiconductor switch. If necessary, the respective heating section can be electrically separated from the power supply in this way and can be deactivated in this way.

According to another advantageous further development, two heating devices are arranged next to one another in the air duct, so that the first and second section portions of the two heating devices are assigned to a total of four different duct zones. This makes it possible to individually heat four different interior zones in the vehicle interior and to supply them with an individual heating power. In other further developments of the invention, it is possible, on principle, to arrange a different number of heating devices, in particular three or more heating devices, next to one another, so as to individually heat a generally arbitrary number of different interior zones in this way or to supply them with an individual heating power, respectively.

The invention further relates to a motor vehicle comprising a vehicle interior, which has at least a first and a second interior zone. The motor vehicle furthermore comprises an arrangement introduced above comprising an air duct and at least one heating device. The above-described advantages of the arrangement thus also transfer to the motor vehicle according to the invention. The air duct of the arrangement and the vehicle interior of the motor vehicle are thereby adapted to one another in such a way that the air, which flows through the first duct zone, essentially reaches into the first interior zone, and the air, which flows through the second duct zone, essentially reaches into the second interior zone.

According to a preferred embodiment of the motor vehicle, the first interior zone comprises a sitting area for a driver of the motor vehicle in the vehicle interior. The second interior zone furthermore comprises a sitting area for a passenger of the motor vehicle in the vehicle interior.

Further important features and advantages of the invention follow from the subclaims, from the drawing, and from the corresponding FIGURE description by means of the drawing.

### BRIEF DESCRIPTION OF THE DRAWINGS

The FIGURE illustrates exemplary embodiments of the disclosure and will be described in more detail in the following description.

It goes without saying that the above-mentioned features and the features, which will be described below, cannot only be used in the respectively specified combination, but also in other combinations or alone, without leaving the scope of the present invention.

### DETAILED DESCRIPTION

The sole FIGURE shows, in a highly simplified illustration, an example of an arrangement 10 according to the invention for heating a vehicle interior (not shown) of a motor vehicle. The arrangement 10 comprises an air duct 3, which extends along a direction of extension ER and is defined by a duct housing 2, for air L to flow through. The air L is heated by means of the heating device 1, before it is introduced into the vehicle interior, whereby the vehicle interior is heated.

The FIGURE shows the air duct 3 in a cross section perpendicular to the direction of extension ER. In the cross section, the air duct 3 is thus divided into a first duct zone 4a, which which air L can be introduced into a first interior zone the vehicle interior, and into a second duct zone 4b, via which air L can be introduced into a second interior zone of the vehicle interior.

In other words, air L, which passes through the first duct zone 4a along the direction of extension ER, is subsequently guided into the first interior zone of the vehicle interior by means of suitable embodiment of the air duct 3. Air L, which passes through the second duct zone 4b along the direction of extension ER, is accordingly guided into the second interior zone by means of suitable embodiment of the air duct 3. For this purpose, it is conceivable to provide a branch on the air duct 3 at a suitable location, from which branch a first partial duct leads into the first interior zone and a second partial duct leads into the second interior zone (not shown). It is also conceivable that the first interior zone comprises a sitting area for a driver of the motor vehicle in the vehicle interior. The second interior zone can accordingly comprise a sitting area for a passenger of the motor vehicle in the vehicle interior.

The arrangement 10 further comprises a heating device 1 arranged in the air duct 3 comprising a plurality of heating sections 5 extending in the air duct 3. The heating sections 5 extend along a longitudinal direction LR, which runs perpendicular to the direction of extension ER. The heating sections 5 are also arranged adjacent and at a distance from one another perpendicular to the longitudinal direction and direction of extension SR, LR along a stack direction SR. The stack direction SR defines a transverse direction QR of the heating sections 5, which runs perpendicular to the longitudinal direction LR. Each heating section 5 thereby has at least one electrical PTC heating element 6 for heating the air L in response to passing through the heating section 5. Each heating section 5 is divided into a first section portion 7a, which is arranged in the first duct zone 4a, and into a second section portion 7b, which is arranged in the second duct zone 4b. Said branch can thereby in particular be provided in a portion of the air duct 3, in which the heating sections 5 comprising the PTC heating elements 6 are arranged.

Advantageously, the electrical PTC heating elements 6 are embodied as identical parts. This means IB that all PTC heating elements 6 generate the same heating power, when they in each case obtain the same electrical power from an electrical power supply.

The heating sections 5 of the heating device 1 comprising the PTC heating elements 6 are arranged in a plane Z perpendicular to the direction of extension ER. The heating sections 5 extend along a joint longitudinal direction LR and are arranged at a distance from one another with regard to a transverse direction QR running at right angles to the longitudinal direction LR. The air L, which flows through the air duct 3, can thus flow through the spaces 9 formed between two adjacent heating sections 5.

A dividing line T in the form of a straight dividing line, which halves the duct section of the air duct 3 into two duct halves 8a, 8b, which form the first and second duct zone 4a, 4b, can be seen in the cross section shown in the FIGURE perpendicular to the direction of extension ER. The two duct halves 8a, 8b are embodied axially symmetrically and are arranged relative to one another, wherein the dividing line T defines the axis of symmetry.

As is also shown in the FIGURE, a cross sectional surface of the first duct zone 4a or of the first duct half 8a, respectively, is of the same size as a cross sectional surface of the second duct zone 4b or of the second duct half 8b, respectively, in the cross section perpendicular to the direction of extension ER.

As can further be seen in the FIGURE, the first section portions 7a are either realized as first section portions of the first type 7a.1 and first section portions of the second type 7a.2. The first section portions of the first type 7a.1 differ from those of the second type 7a.2 in the number of PTC heating elements 6, which are arranged in the first section portion of the first or second type 7a.1, 7a.2, respectively.

The second section portions 7b are analogously either realized as second section portions of the first type 7b.1 or as second section portions of the second type 7b.2. The second section portions of the first type 7b.1 differ from those of the second type 7b.2 in the number of PTC heating elements 6, which are arranged in the second section portion of the first or second type 7b.1, 7b.2, respectively.

According to the FIGURE, a first section portion 7a.1 of the first type, which has a first number a1 of PTC heating elements 6, is in each case arranged along the stack direction SR adjacent to a first section portion of the second type 7a.2, which has a second number a2 of PTC heating elements 6, which differs from the first number a1. In the example of the FIGURE, a1=3 and a2=1. A second section portion of the first type 7b.1, which has a first number b1 of PTC heating elements 6, is likewise arranged along the stack direction SR adjacent to a second section portion 7b.2 of the second hype, which has a second number b2 of PTC heating elements 6, which differs from the first number b1. In the example of the FIGURE, b1=1 and b2=3. In each case, two first section portions 7a.1, 7a.2, which are adjacent in the stack direction SR, thus have a different number a1, a2 of PTC heating elements 6. In each case, two second section portions 7b.1, 7b.2, which are adjacent in the stack direction SR, likewise have a different number b1, b2 of PTC heating elements 6.

In the example scenario of the FIGURE, first section portions of the first type 7a.1 and first section portions of the second type 7a.2 alternate along the stack direction SR.

Second section portions of the first type 7b.1 and second section portions of the second type 7b.2 likewise alternate along the stack direction SR.

According to the FIGURE, the number of all PTC heating elements 6, which are present in the first and second section portions of the first type 7a.1, 7b.1, can be identical to the number of all PTC heating elements 6, which are present in the first and second section portions of the second type 7a.2, 7b.2. According to the FIGURE, a number n1 of all electrical PTC heating elements 6, which are arranged in the first section portions of the first and second type 7a.1, 7a.2, is identical to a number n2 of all electrical PTC heating elements 6, which are arranged in the second section portions of the first and second type 7b.1, 7b.2. In the example scenario, a different number of electrical PTC heating elements 6 is further arranged in a first section portion of the first type 7a.1 of a respective heating section 5 than in the second section portion 7b.1 thereof. A different number of electrical PTC heating elements 6 is likewise arranged in a first section portion of the second type 7a.2 of a respective heating section 5 than in the second section portion 7b.2 thereof.

The arrangement of an electrical PTC heating element 6 can optionally be forgone (not shown) in one or in a plurality of heating sections 5 in the first or in the second section portion thereof of the first or second type 7a.1, 7b.1, 7a.2, 7b2, respectively.

During operation of the heating device 1, all electrical PTC heating elements 6 are connected to an electrical power supply, which is not illustrated in detail in the FIGURE. The electrical wiring of the PTC heating elements 6 to the electrical power supply is thereby realized in such a way that all PTC heating elements 6 obtain the same heating power from the electrical power supply during operation of the heating device 1. Due to the fact that the PTC heating elements 6 are embodied as identical parts and the same number of PTC heating elements 6 is arranged in the first duct zone 4a as in the second duct zone 4b, the totality of all electrical PTC heating elements, which are arranged in the first duct zone, generate a first electrical total heating power P1, which is identical to a second electrical total heating power P2, which is generated by all PTC heating elements, which are arranged in the second duct zone. Both interior zones are thus supplied with the same heating power.

The individual heating sections 5 can in each case be electrically connected to the electrical power supply by means of a semiconductor switch (not shown), for example in the form of a power transistor, so that they can be electrically separated from the power supply.

1. An arrangement for heating a vehicle interior of a motor vehicle, comprising:
an air duct extending along a direction of extension and being defined by a duct housing, for air to flow through, which, in a cross section perpendicular to the direction of extension, comprises a first duct zone, via which the air can be introduced into a first interior zone of the vehicle interior, and a second duct zone, via which the air can be introduced into a second interior zone of the vehicle interior,
at least one heating device arranged in the air duct, including a plurality of heating sections, which extend along a longitudinal direction and perpendicular to the direction of extension in the air duct, having electrical PTC heating elements, and being arranged adjacent to one another along a stack direction perpendicular to the longitudinal direction and direction of extension,
wherein each heating section is divided at least into a first section portion, which is arranged in the first duct zone, and into a second section portion, which is arranged in the second duct zone, and
wherein, in each case, two first section portions, which are adjacent in the stack direction, have a different number of PTC heating element heating elements and wherein, in each case, two second section portions, which are adjacent in the stack direction, have a different number of PTC heating elements.

2. The arrangement according to claim 1, further comprising at least one of:
a first section portion of the first type, which has a first number of PTC heating elements, is arranged along the stack direction adjacent to a first section portion of the second type, which has a second number of PTC heating elements, which differs from the first number, and
a second section portion of the first type, which has a first number of PTC heating elements, is arranged along the stack direction adjacent to a second section portion of the second type, which has a second number of PTC heating elements, which differs from the first number.

3. The arrangement according to claim 1, wherein at least one of:
first section portions of the first type and first section portions of the second type alternate along the stack direction; and
second section portions of the first type and second section portions of the second type alternate along the stack direction.

4. The arrangement according to one of claim 1, wherein the number of all electrical PTC heating elements, which are arranged in the first section portions, is identical to the number of all electrical PTC heating elements, which are arranged in the second section portions.

5. The arrangement according to claim 1, wherein the number of all PTC heating elements, which are present in the first and second section portions of the first type, is identical to the number of all PTC heating elements, which are present in the first and second section portions of the second type.

6. The arrangement according to claim 1, wherein a different number of electrical PTC heating elements is provided in at least one heating section, in at least two heating sections, in all heating sections, in the first section portion thereof of the first or second type than in the second section portion thereof of the first or second type.

7. The arrangement according to claim 1, wherein no electrical PTC heating element is arranged in at least one heating section, in at least two heating sections, in the first or in the second section portion.

8. The arrangement according to claim 1, wherein the heating sections comprising the PTC heating elements are arranged in a plane perpendicular to the direction of extension.

9. The arrangement according to claim 1, wherein a cross sectional surface of the first duct zone is of the same size as a cross sectional surface of the second duct zone in the cross section perpendicular to the direction of extension.

10. The arrangement according to claim 1, wherein an axis of symmetry, which halves the duct section of the air duct into two duct halves arranged axially symmetrically to one another, which form the first and second duct zone, is present in the cross section perpendicular to the direction of extension.

11. The arrangement according to claim 1, wherein the heating sections extend along a joint longitudinal direction and are arranged at a distance from one another with regard to a transverse direction running at right angles to the longitudinal direction, so that the air can pass through the spaces, which are formed between two adjacent heating sections.

12. The arrangement according to claim 1, wherein the PTC heating elements are embodied as identical parts.

13. The arrangement according to claim 1, wherein the PTC heating elements are connected to an electrical power supply during operation of the heating device, so that a first electrical total heating power is generated by means of the totality of all electrical PTC heating elements, which are arranged in the first duct zone, which first electrical total heating power differs from a second electrical total heating power, which is generated by all PTC heating elements, which are arranged in the second duct zone.

14. The arrangement according to claim 13, wherein at least one heating section is electrically connected to the electrical power supply by a semiconductor switch, so that said heating section can be electrically separated from the power supply.

15. A motor vehicle comprising including a vehicle interior with a first and a second interior zone, comprising:
an air duct extending along a direction of extension and being defined by a duct housing, the air duct including a first duct zone to introduce air into a first interior zone of the vehicle interior, and a second duct zone to introduce air into a second interior zone of the vehicle interior;
at least one heating device arranged in the air duct including a plurality of heating sections,
wherein at least one of the plurality of heating sections is divided at least into a first section portion arranged in the first duct zone, and into a second section portion arranged in the second duct zone,
wherein at least one of the plurality of heating sections includes two first section portions that are adjacent in the stack direction and have a different number of PTC heating element heating elements,
wherein at least one of the plurality of heating sections includes two second section portions that are adjacent in the stack direction and have a different number of PTC heating elements, and
wherein the air duct and the vehicle interior are adapted to one another in such a way that the air, which flows through the first duct zone reaches into the first interior zone, and the air, which flows through the second duct zone reaches into the second interior zone.

16. The motor vehicle according to claim 15, wherein the first interior zone comprises a sitting area for a driver of the motor vehicle in the vehicle interior, and the second interior zone comprises a sitting area for a passenger of the motor vehicle in the vehicle interior.

17. A system for motor vehicle including a vehicle interior with a first interior zone and a second interior zone, comprising:
an air duct extending along a direction of extension and being defined by a duct housing, the air duct including a first duct zone to introduce air into a first interior zone of the vehicle interior, and a second duct zone to introduce air into a second interior zone of the vehicle interior;
at least one heating device arranged in the air duct including a plurality of heating sections,
wherein at least one of the plurality of heating sections is divided at least into a first section portion arranged in the first duct zone, and into a second section portion arranged in the second duct zone,
wherein at least one of the plurality of heating sections includes two first section portions that are adjacent in the stack direction, and
wherein at least one of the plurality of heating sections includes two second section portions that are adjacent in the stack direction.

18. The system of claim 17, wherein the two first section portions have a different number of PTC heating element heating elements and the two second section portions have a different number of PTC heating elements

19. The system according to claim 18, further comprising at least one of:
a first section portion of the first type, which has a first number of PTC heating elements, is arranged along the stack direction adjacent to a first section portion of the second type, which has a second number of PTC heating elements, which differs from the first number, and
a second section portion of the first type, which has a first number of PTC heating elements, is arranged along the stack direction adjacent to a second section portion of the second type, which has a second number of PTC heating elements, which differs from the first number.

20. The system according to claim 17, wherein at least one of:
first section portions of the first type and first section portions of the second type alternate along the stack direction; and
second section portions of the first type and second section portions of the second type alternate along the stack direction.
